(19) United States
(12) Patent Application Publication
(10) Pub. No.: US 2015/0317665 A1
(43) Pub. Date: Nov. 5, 2015

(54) Credit Card Reward Program Incorporating Investing in Precious Metals

(71) Applicant: Richard Hajdukiewicz, New York, NY (US)

(72) Inventor: Richard Hajdukiewicz, New York, NY (US)

(21) Appl. No.: 14/266,983

(22) Filed: May 1, 2014

(51) Int. Cl. G06Q 30/02; G06Q 20/24; G06Q 20/34

(52) U.S. Cl. CPC G06Q 30/0226; G06Q 20/34; G06Q 20/24

(57) ABSTRACT

In a credit card reward program incorporating investment in precious metals, a credit card holder is provided with a credit card account and a precious metals account. The precious metals account contains balances of one or more precious metals. Cash is accumulated from activity on the credit card account at a reward rate, and may be increased by rounding up transactions on the credit card account and crediting the round-up funds to the total. Periodically, for example monthly, precious metals in proportion to a designated basket are purchased using the cash balance and the metals are added to the balances of metals in the precious metals account. Precious metals may be exchanged for fabricated products in fabrication transactions. Additionally, a precious metal protection program transaction may be provided whereby, for a fee, a price cap may be obtained for the duration of a program period.

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to credit card rewards programs and in particular to credit card rewards programs incorporating investing in precious metals. Credit card accounts are well known, and a consistent feature of credit card accounts is the high fees charged to merchants by credit card issuers. To increase the rate of use of credit cards and correspondingly, the rate of accumulation of merchant fees, credit card issuers have traditionally offered credit card holders with reward features of various kinds as an incentive to transact on the credit card account more frequently. Traditional credit card rewards programs include periodic cash back credits to the credit card account, frequent flier miles, and points that may be exchanged directly for goods and services.

Within the field of credit card rewards programs are rewards programs that offer investment opportunities. For example, U.S. Pat. No. 5,787,404, issued Jul. 28, 1998 to Fernandez-Holmann teaches a credit card rewards program that supports contribution to a retirement account or other long term investment fund. Similarly, U.S. Pat. No. 6,895,386, issued May 17, 2005 to Bachman teaches a credit card rewards program that provides periodic purchases of a stock, and U.S. Pat. No. 6,941,279, issued Sep. 6, 2005 to Sullivan, teaches a credit card rewards program that provides periodic purchases of a mutual fund.

Lacking, however, from the field of investment-oriented credit card rewards programs are credit card rewards programs that offer investment in precious metals. This absence may be due to the cost and difficulty of managing the physical underlying asset, which has no equivalent in investment vehicles based on securities. Additionally, investors in precious metals may wish to engage in fabrication transactions, whereby a portion of the held metals may be converted into fabricated products, such as jewelry, coins, bars, wafers, grains, etc. This transaction similarly has no equivalent in investment vehicles based on securities. Further, investing directly in precious metals, especially in small quantities, can be difficult for the consumer whose access to metals dealers or metals-based financial instruments may be limited.

A credit card rewards program that offers the credit card holder with the opportunity to easily and simply invest in precious metals would address the above-discussed shortcomings. Such a program could offer the ability to easily convert metals to fabricated products, and such a program could offer price cap protection to help the credit card holder in planning fabrication transactions.

### SUMMARY OF THE INVENTION

Accordingly, the invention is directed to a credit card reward program incorporating investment in precious metals. A credit card holder is provided with a credit card account from a credit card issuer and a precious metals account from a program manager. Program fees may be paid from the credit card issuer to the program manager from merchant fees and fees charged to the credit card account, or may be paid by selling metal in the precious metals account. The precious metals account contains balances of one or more precious metals selected from the group of gold, silver, platinum, and other metals. Cash is accumulated from activity on the credit card account at a reward rate, and may be increased by rounding up transactions on the credit card account and crediting the round-up funds to the total. Periodically, for example monthly, precious metals in proportion to a designated basket are purchased using the cash balance and the metals are added to the balances of metals in the precious metals account. Precious metals may be exchanged for fabricated products in fabrication transactions. Additionally, a precious metal protection program transaction may be provided whereby, for a fee, a price cap may be obtained for the duration of a program period.

The program manager may contract with custodians for the storage and management of physical precious metals, and may pay the custodians a service fee. The program manager may contract with fabricators and suppliers to offer a selection of fabricated products, for example metal bars, wafers, grain, coins, and jewelry. The program manager may pay the fabricator or supplier a service fee, and may charge the credit card holder a transaction. The program manager may transact on a metals market to effect spot transactions by the credit card holder, realize revenue from metals, and to implement hedging for precious metal protection program transactions.

It is an object of the invention to provide a credit card rewards program that enables the credit card holder to easily and simply invest in precious metals.

It is a further object of the invention to provide a credit card rewards program that enables the credit card holder to engage in periodic investing in precious metals.

It is a further object of the invention to provide a credit card rewards program that enables the credit card holder to convert precious metals into jewelry, coins, bars, wafers, grains, and other fabricated products.

It is a further object of the invention to provide a credit card rewards program that enables the credit card holder to purchase price caps on precious metals and to thereby protect the price of future purchases of jewelry, coins, bars, wafers, grains, and other fabricated products.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a network diagram of the components of the first exemplary embodiment, displaying the credit card holder 100, the credit card issuer 101, the program manager 102, the precious metals account 103, the cash balance 10, the available gold 11, the available silver 12, the available platinum 13, the available other metals 15, the credit card account 104, the unrelated cash, deposit, credit card, and investment accounts (“Unrelated Accounts”) 105, the custodians 106, the fabricators/suppliers 107, the metals market 108, the merchant fees 109, the program fees 110, the service fees 111, and the transaction fees 112.

FIG. 2 is a flowchart diagram describing a spot purchase of precious metal transaction, displaying steps 200-207, the market price 20, the spot price 21, and Quantity 22.

FIG. 3 is a flowchart diagram describing a spot sale of precious metal transaction, displaying steps 300-307, the market price 30, and the spot price 31.

FIG. 4 is a flowchart diagram describing a periodic purchase of precious metals transaction, displaying steps 400-408, the basket 40, the periodic purchase period 41, and the reward rate 42.

FIG. 5 is a flowchart diagram describing a fabrication transaction, displaying steps 500-506, the selection 50, the quantity 51, and the fabricated product 52.

FIG. 6 is a flowchart diagram describing a precious metal protection program transaction, displaying steps 600-611, the market price 60, cap price 61, program period 63, cap fee 64, total cap fee 66, and cap quantity 68.

### DETAILED DESCRIPTION OF THE INVENTION

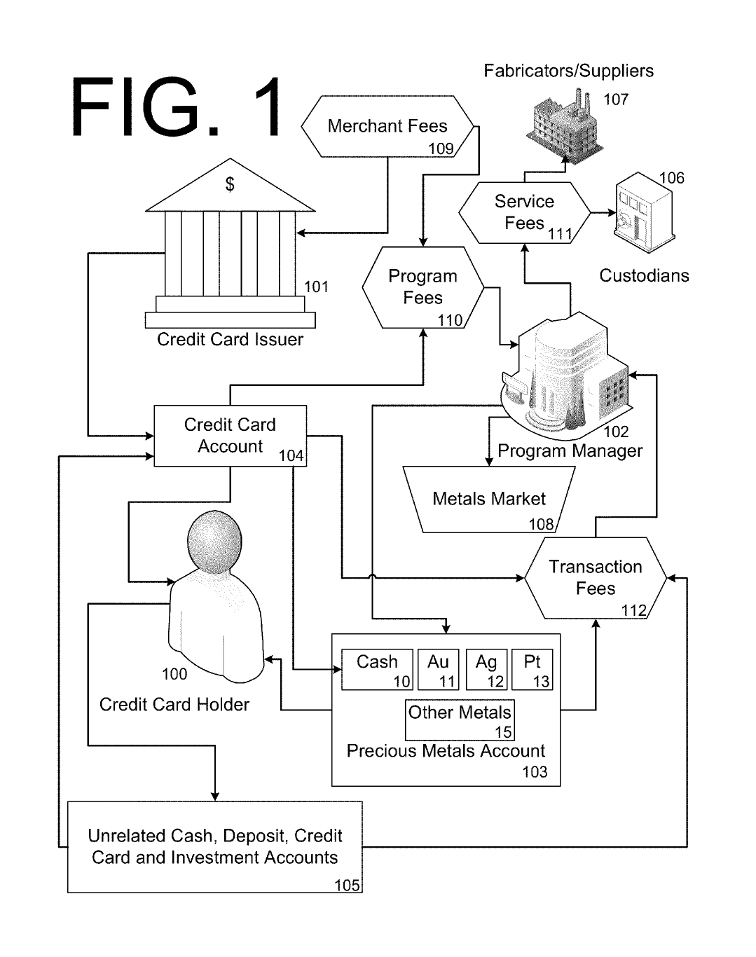

Referring now to the invention in more detail, the invention is directed to a credit card reward program incorporating investment in precious metals, and to business methods and systems relating thereto and to computer software implementing the same. FIG. 1 is a network diagram showing the components of the system. A credit card holder 100, one of a large plurality of credit holders, is provided with a credit card account 104 from a credit card issuer 101 and a precious metals account 103 from a program manager 102. Within the precious metals account 103 are multiple balances including available gold 11, available silver 12, available platinum 13, and available other metals 15. A temporary cash balance 10 represents rewards earned from activity on the credit card account 104, but not yet consumed in purchasing precious metals. The available metals 11-15 are preferably expressed in units of mass or weight of metal at a given purity (preferably a high or investment grade purity). While the invention is principally directed to trading precious metals, the business methods and system described herein may be understood as applicable to base metals and other commodities as well.

The cash balance 10 is normally accumulated through ordinary transactions on the credit card account 104 by the credit card holder 100, whereby the transaction total yields rewards cash at a given rate, for example $5 per $1000 of credit card transactions (equivalent to 0.5%). The cash balance 10 may be supplemented by rounding up transactions on the credit card account 104 and adding the rounded-up funds to the cash balance 10. The cash balance 10 is preferably swept or consumed periodically, for example monthly, and used to purchase precious metals in proportion to a designated basket 40. Accounting of the cash balance 10 may be maintained by the credit card issuer 101 for periodic payment to the program manager 102, or may be maintained by the program manager 102. Payments from or to the credit card holder 100 for fees or sale proceeds may be charged or credited in precious metals to the metals balances 11-15, or in cash to the credit card account 104, or to one or more unrelated cash, deposit, credit card, or investment accounts (“Unrelated Accounts”) 105 of the credit card holder 100.

The program manager 102 maintains the precious metals account 103 and may implement precious metals transactions by buying or selling metals, metals futures, or other instruments on a metals market 108. The accounting and transactions, including electronic access thereto by the credit card holder 100, may be implemented in computer software using known software methods. The program manager may further maintain its own portfolio of precious metals and metals-related instruments for the purpose of covering or hedging transactions.

Where the program manager 102 holds physical precious metals, the program manager 102 may contract with one or more custodians 106 who preferably operates a vault or other secure storage facility where physical metals may be kept, and may pay service fees 111 to the custodians 106. The program manager 102 may contract with fabricators/suppliers 107 for services related to producing or obtaining fabricated products. Examples of fabricated products include jewelry, coins, bars, wafers, and grains. A fabricator 107 may directly accept metal for fabrication from the program manager 102, or may supply, from separate sources, an equivalent weight or mass of metal to that of the transaction. A supplier may provide pre-fabricated and separately sourced jewelry, coins, bars, wafers, grains, etc. at an equivalent weight or mass of metal to that of the transaction. In addition to providing metals as raw material or paying the cost of obtaining metals or pre-finished fabricated goods, the program manager may pay service fees 111 to the fabricators/suppliers 107.

The program manager 102 may collect fees in a number of ways. Program fees 110 represent fees paid to the program manager 102 for its services in maintaining the precious metals account 103 and providing for the storage, handling, shipping, and transacting of the underlying metals. Program fees 110 may be deducted periodically by selling metals in the precious metals account, or may be charged periodically to the credit card account 104 as an annual or monthly fee. Program fees may also be represented by a share of merchant fees 109, which represent the ordinary fees paid by merchants to the credit card issuer 101.

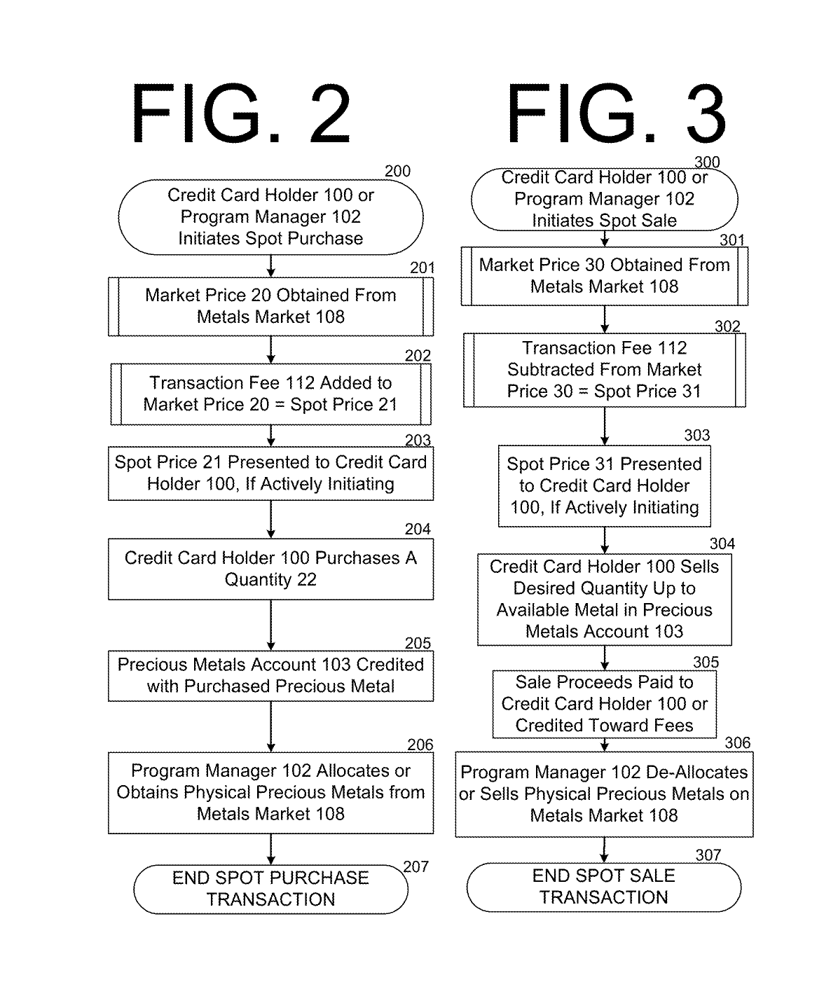

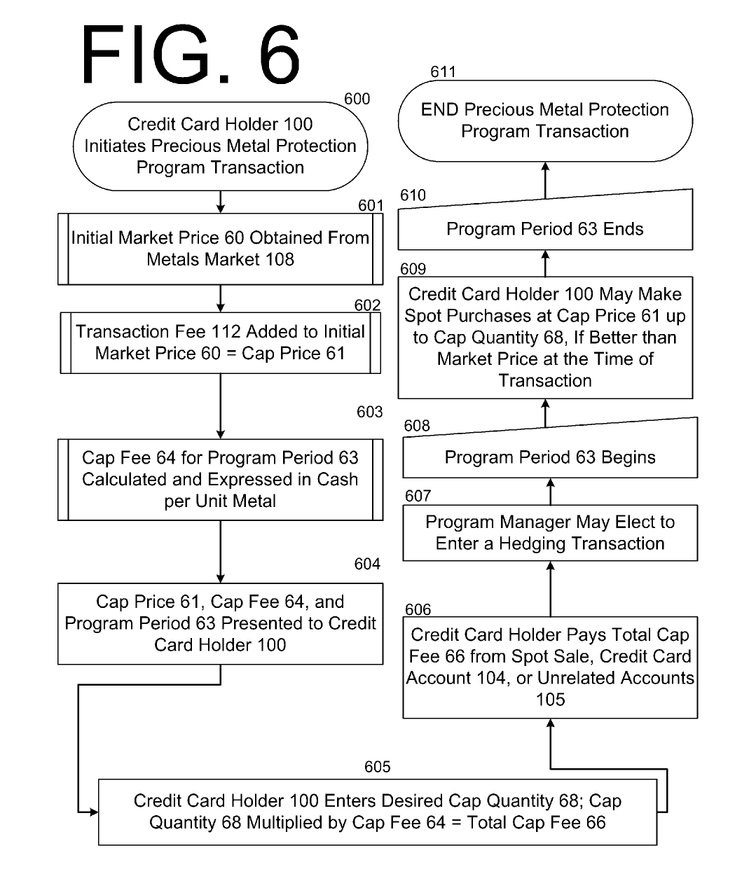

Additionally, transaction fees 112 represent fees paid to the program manager 102 for a particular transaction. Transaction fees 112 may be built into the transaction price; for example a spot purchase (FIG. 2) price may include a markup over the market price, and a spot sale (FIG. 3) price may include a markdown under the market price, with the difference representing the transaction fee 112. Transaction fees 112 may be set off explicitly, for example in a fabrication transaction (FIG. 5) may be associated with an explicit fabrication fee. Similarly, in a precious metals protection program transaction (FIG. 6), an explicit cap fee may be associated with the transaction. Transaction fees 112, whether explicit or included in a price, may generally be denominated in cash, and may be paid from the cash balance 10, the credit card account 104, Unrelated Accounts 105, or may be funded by the proceeds of a spot sale of available gold 11, available silver 12, available platinum 13, or available other metals 15.

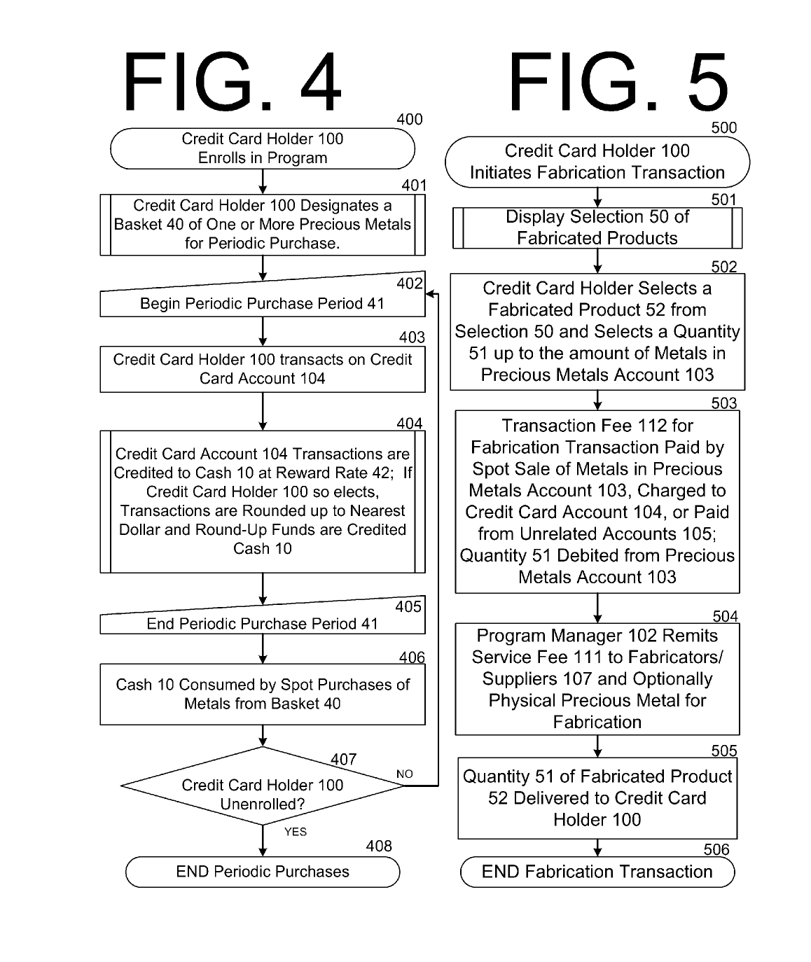

Referring now to FIG. 2, FIG. 2 shows a flowchart diagram of a spot purchase transaction. A spot purchase transaction may be initiated by either by the program manager 102 (when periodically purchasing metals) or the credit card holder 100, for example through a remote electronic communication interface such as an Internet application, or alternatively through a live or machine-operated telephone conversation, by mail or otherwise (Step 200). A market price 20 is obtained from the metals market 108 (Step 201). The specific transaction fee 112 is added to the market price 20 to yield a spot price 21 (Step 202). The spot price 21 may be presented to the credit holder 100, preferably in real time (Step 203). A quantity 22 is designated, either by the credit card holder 100 directly or by the program manager 102 according to the periodic purchase transaction (FIG. 4), and the quantity 22 is purchased (Step 204). The spot purchase may be paid for by sweeping the cash balance 10 (see FIG. 4). Where the credit card holder 100 has initiated a one-off spot purchase, the spot purchase may be paid for by selling other metals, by charging the credit card account 104 or by charging Unrelated Accounts 105 as designated by the credit card holder 100 (Step 204). The purchased metal is then credited to the precious metals account 103 in the appropriate balance of available gold 11, available silver 12, available platinum 13, or available other metals 15 (Step 205). The program manager 102 then allocates existing precious metals to the credit card holder 102 or obtains additional precious metals from the metals market 108 (Step 206). The spot purchase is then concluded (Step 207).

Referring now to FIG. 3, FIG. 3 shows a flowchart diagram of a spot sale transaction. A spot sale transaction may be initiated by the credit card holder 100, for example through a remote electronic communication interface such as an Internet application, or alternatively through a live or machine-operated telephone conversation, by mail or otherwise (Step 300). Alternatively, a spot sale may be initiated by the program manager 102 on behalf of the credit card holder 100 for the purpose of paying program fees 110 or transaction fees 112. A market price 30 is obtained from the metals market 108 (Step 301). The specific transaction fee 112 is subtracted from the market price 30 to yield a spot price 31 (Step 302). The spot price 31 may be presented to the credit holder 100, preferably in real time (Step 303), or not at all when the program manager 102 initiates the spot sale. The credit card holder then designates the desired quantity for sale up to the available metal in the precious metals account 103 (Step 304). The sold metal is then debited from the precious metals account 103 in the appropriate balance of available gold 11, available silver 12, available platinum 13, or available other metals 15 (Step 304). The spot sale proceeds are applied to program fees 110 or transaction fees 112, or paid out the credit card holder 100 (Step 305). The program manager 102 then de-allocates existing precious metals to from the credit card holder 102 and may elect to sell precious metals on the metals market 108 (Step 306). The spot sale is then concluded (Step 307).

Referring now to FIG. 4, FIG. 4 shows a flowchart diagram of a periodic purchase transaction. The user initiates the periodic purchase transaction by enrolling in the credit card rewards program; enrollment may be made available through a remote electronic communication interface such as an Internet application, or alternatively through a live or machine-operated telephone conversation, by mail or otherwise (Step 400). The credit card holder may elect, at the time of enrollment or at another time, whether to make round-up purchases. The credit card holder 100 designates a basket 40 of metals for purchase (Step 401). The basket 40 is preferably expressed as a group of one or more ratios or percentages whose sum is 1 or 100%. Each ratio in the basket 40 represents the proportion of a periodic purchase of a particular precious metal. The periodic purchase transaction occurs over a periodic purchase period 41, for example one month. A one-month periodic purchase period 41 may be aligned with the statement period of the credit card account 104 for convenient accounting. The periodic purchase then begins (Step 402). During the periodic purchase period 41, transactions on the credit card account 104 (Step 403) are credited to the cash balance 10 at a reward rate 42, for example 0.5% or $5 per $1,000 in credit card transactions (Step 404). If the credit card holder 100 has elected to engage in round-up purchases, then transactions on the credit card account 104 may be rounded up to the next whole dollar or other rounding amount (equivalent whole units or other amounts of other currencies may be used where the invention is practiced outside of the United States), and the additional funds (the difference between the round-up transaction charge and the actual merchant charge) are added to the cash balance 10, preferably at a rate of 1:1 (Step 404). The periodic purchase period 41 ends (Step 405). The cash balance 10 is then consumed down as close to a zero as possible by spot purchases of metals in proportion to the ratios of the basket 40 (Step 406). Any amount unable to be spent may be carried forward to the next periodic purchase period 41 or paid back to the credit card holder 100. Whether the credit card holder 100 has unenrolled is checked (Step 407). If the credit card holder 100 has not unenrolled, then the periodic purchase period 41 begins again (Step 402). If the credit card holder 100 has unenrolled, then the periodic purchase transaction ends (Step 408).

Referring now to FIG. 5, FIG. 5 shows a flowchart diagram of a fabrication transaction. A fabrication transaction may be initiated by the credit card holder 100, for example through a remote electronic communication interface such as an Internet application, or alternatively through a live or machine-operated telephone conversation, by mail or otherwise (Step 500). The credit card holder is presented with a selection 50 of fabricated products (Step 501). Fabricated products are generally understood as articles of manufacture made predominantly of precious metal and primarily valued, at the time of production, based upon their weight or mass of precious metal. Examples of fabricated products include jewelry, coins, bars, wafers, and grains of precious metal. The program manager 102 may provide one or fabricated products by contracting with fabricators/suppliers as discussed above. The credit card holder 100 selects a particular fabricated product 52 from the selection 50 and selects a quantity 51 up to the weight of available gold 11, silver 12, platinum 13, or other metals 15 in the precious metals account 103 (Step 502). The quantity 51 may be expressed as the weight or mass of one object or of multiple objects in combination. Additional metals may be spot-purchased as above to make up weight or mass needed for the credit card holder 100′s desired quantity. The transaction fee 112 is assessed and paid with spot sales or cash charged to the credit card account 104 or Unrelated Accounts 105, and the quantity 51 is debited from the available gold 11, silver 12, platinum 13, or other metals 15 in the precious metals account 103 (Step 503). The program manager 102 then remits a service fee 111 and the physical metal or cost of the physical metal to a fabricator/supplier 107 (Step 504). The fabricated product 52 is then delivered to the credit card holder 100 (Step 505). The credit card holder 100 need not take deliver directly, but may instead designate a bank or other custodian to receive said fabricated product and store it securely, or the program manager 102 may retain the fabricated product securely on behalf of the credit card holder 100. The fabrication transaction is then completed (Step 506).

Referring now to FIG. 6, FIG. 6 shows a flowchart diagram of a precious metal protection program transaction. A precious metal protection program transaction may be initiated by the credit card holder 100, for example through a remote electronic communication interface such as an Internet application, or alternatively through a live or machine-operated telephone conversation, by mail or otherwise (Step 600). An initial market price 60 is obtained from the metals market 108 (Step 601). The specific transaction fee 112 is added to the initial market price 60 to yield a cap price 61 (Step 602). A cap fee 64 for a program period 63 is calculated; the amount of the cap fee is preferably sufficient to compensate the program manager for the risk that the cap will be exercised, and the amount of the cap fee is determined according to known principles of financial instrument valuation and actuarial science. The program period 63 is preferably several months in length, for example one month, three months, six months, etc. The cap fee 64 is expressed in currency per unit metal, for example $10 per ounce of gold (Step 603). The cap price 61, the cap fee 64, and the program period 63 are presented to the credit card holder 100 (Step 604). The credit card holder 100 selects a desired cap quantity 68, expressed as a weight or mass of metal, and the cap quantity 68 is multiplied by the cap fee 64 to yield the total cap fee 66 (Step 605). The credit card holder 100 may then pay the total cap fee 65; payment may be made from by selling metals in the precious metals account 103 or in cash charged to the credit card account 104 or Unrelated Accounts 105 in accordance with transaction fee 112 payments, discussed above (Step 606). The program manager 102 may then elect to make a hedging transaction (Step 607). The program period 63 begins (Step 608). At any time during the program period, the credit card holder 100 may make spot purchases at the cap price 62 up to the cap quantity 68, if the cap price is lower than the market price at the time of the spot purchase (Step 609). The program period 63 ends (Step 610), and the precious metals protection program transaction is concluded (Step 611).

The credit card holder 100 may wish to make a fabrication transaction in the future, but at the current price. In this circumstance, the credit card holder 100 may make a precious metal protection program transaction in the quantity needed for the desired fabrication transaction and over a program period that is at least as long as the time between planning and making the fabrication transaction. The credit card holder may then plan the fabrication transaction and ensure funds are available because the cap price, the maximum unit price for the fabricated product, will be known in advance and protected from sudden price rises.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A credit card reward program comprising:
(a) a credit card issuer;
(b) a credit card holder;
(c) said credit card issuer issuing a credit card account to said credit card holder;
(d) a program manager;
(e) said program manager issuing a precious metals account to said credit card holder;
(f) said precious metals account containing at least one balance of a precious metal;
(g) said credit card holder designating a basket of at least one metal;
(h) a cash balance;
(i) a periodic purchase period;
(j) a reward rate;
(k) the value of said cash balance over said periodic purchase period being equal to the value of all transactions on said credit card account in said periodic purchase period multiplied by said reward rate;
(l) at the end of said periodic purchase period, said cash balance being completely or mostly consumed by spot purchases of precious metals in proportion to said basket of at least one metal, and the resulting purchased metal being credited to said precious metals account; and
(m) said program manager making available to said credit card holder a spot sale transaction wherein some or all of the metals in said precious metals account are sold.

2. The credit card reward system of claim 1 wherein said program manager makes available to said credit card holder a spot purchase transaction wherein said credit card holder makes spot purchases of metal, said spot purchases being paid for from said credit card account from one or more unrelated accounts, and the resulting purchased metal being credited to said precious metals account.

3. The credit card reward system of claim 1 wherein said program manager makes available to said credit card holder a round-up election such that, if said credit card holder makes said round-up election, all transactions on said credit card account during said periodic purchase period are rounded up to the nearest multiple of a rounding amount and, for each transaction on said credit card account in said periodic purchase period, the difference between the rounded up transaction charge and the actual merchant charge is added to said cash balance.

4. The credit card reward system of claim 1 wherein said program manager makes available to said credit card holder a fabrication transaction wherein said credit card holder selects a fabricated product from a selection of fabricated products and selects a quantity of said fabricated product, wherein said quantity is paid for in any combination of metals deducted from said at least one balance of precious metals in said precious metals account and cash charged to said credit card account or from one or more unrelated accounts, and wherein said credit card holder receives said fabricated product.

5. The credit card reward system of claim 1 wherein said program manager makes available to said credit card holder a precious metal protection program transaction wherein a cap price is determined based on an initial market price, wherein a cap fee for the duration of a program period is set, wherein a cap quantity is selected by said credit card holder, wherein said cap fee is multiplied by said cap quantity to yield a total cap fee, wherein said total cap fee is paid by said credit card holder, and wherein, during said program period, said credit card holder may elect to make a spot purchase at said cap price if lower than the market price at the time of said spot purchase.

6. The credit card reward system of claim 1 wherein one or more transactions made available to said credit card holder by said program manager are subject to an explicit transaction fee, and wherein said explicit transaction fee may be paid for in any combination of spot sales of metals in said precious metals account and cash charged to said credit card account or from one or more unrelated accounts.

7. The credit card reward system of claim 2 wherein one or more transactions made available to said credit card holder by said program manager are subject to an explicit transaction fee, and wherein said explicit transaction fee may be paid for in any combination of spot sales of metals in said precious metals account and cash charged to said credit card account or from one or more unrelated accounts.

8. The credit card reward system of claim 3 wherein one or more transactions made available to said credit card holder by said program manager are subject to an explicit transaction fee, and wherein said explicit transaction fee may be paid for in any combination of spot sales of metals in said precious metals account and cash charged to said credit card account or from one or more unrelated accounts.

9. The credit card reward system of claim 4 wherein one or more transactions made available to said credit card holder by said program manager are subject to an explicit transaction fee, and wherein said explicit transaction fee may be paid for in any combination of spot sales of metals in said precious metals account and cash charged to said credit card account or from one or more unrelated accounts.

10. The credit card reward system of claim 5 wherein one or more transactions made available to said credit card holder by said program manager are subject to an explicit transaction fee, and wherein said explicit transaction fee may be paid for in any combination of spot sales of metals in said precious metals account and cash charged to said credit card account or from one or more unrelated accounts.

11. The credit card reward system of claim 9 wherein said fabrication transaction is subject to said explicit transaction fee.

12. The credit card reward system of claim 10 wherein said cap fee is an explicit transaction fee.

13. The credit card reward system of claim 4 wherein said program manager makes available to said credit card holder a precious metal protection program transaction wherein a cap price is calculated determined based on an initial market price, wherein a cap fee for the duration of a program period is set, wherein a cap quantity is selected by said credit card holder, wherein said cap fee is multiplied by said cap quantity to yield a total cap fee, wherein said total cap fee is paid by said credit card holder, and wherein, during said program period, said credit card holder may elect to make a spot purchase at said cap price if lower than the market price at the time of said spot purchase.

14. The credit card reward program of claim 13 wherein said credit card holder plans one or more instances of said fabrication transaction in the future, and wherein said credit card holder makes one or more instances of said precious metal protection program transactions, said cap quantity being sufficient for said one or more instances of said fabrication transaction, and said program period being at least as long as the time between said one or more instances of said precious metal protection program transaction and the planned time of said one or more instances of said fabrication transaction.

15. The credit card reward system of claim 14 wherein one or more transactions made available to said credit card holder by said program manager are subject to an explicit transaction fee, and wherein said explicit transaction fee may be paid for in any combination of spot sales of metals in said precious metals account and cash charged to said credit card account or from one or more unrelated accounts; and wherein said fabrication transaction is subject to said explicit transaction fee; and wherein said cap fee is an explicit transaction fee.

16. The credit card reward system of claim 15 wherein said program manager makes available to said credit card holder a spot purchase transaction wherein said credit card holder makes spot purchases of metal, said spot purchases being paid for from said credit card account from one or more unrelated accounts, and the resulting purchased metal being credited to said precious metals account.

17. The credit card reward system of claim 15 wherein said program manager makes available to said credit card holder a round-up election such that, if said credit card holder makes said round-up election, all transactions on said credit card account during said periodic purchase period are rounded up to the nearest multiple of a rounding amount and, for each transaction on said credit card account in said periodic purchase period, the difference between the rounded up transaction charge and the actual merchant charge is added to said cash balance.

18. The credit card reward system of claim 16 wherein said program manager makes available to said credit card holder a round-up election such that, if said credit card holder makes said round-up election, all transactions on said credit card account during said periodic purchase period are rounded up to the nearest multiple of a rounding amount and, for each transaction on said credit card account in said periodic purchase period, the difference between the rounded up transaction charge and the actual merchant charge is added to said cash balance.

19. The credit card reward system of claim 5 wherein said program manager makes available to said credit card holder a round-up election such that, if said credit card holder makes said round-up election, all transactions on said credit card account during said periodic purchase period are rounded up to the nearest multiple of a rounding amount and, for each transaction on said credit card account in said periodic purchase period, the difference between the rounded up transaction charge and the actual merchant charge is added to said cash balance.

20. The credit card reward system of claim 6 wherein said program manager makes available to said credit card holder a round-up election such that, if said credit card holder makes said round-up election, all transactions on said credit card account during said periodic purchase period are rounded up to the nearest multiple of a rounding amount and, for each transaction on said credit card account in said periodic purchase period, the difference between the rounded up transaction charge and the actual merchant charge is added to said cash balance.
